(19) United States
(12) Patent Application Publication
(10) Pub. No.: US 2011/0112811 A1
(43) Pub. Date: May 12, 2011

(54) COMPUTER ALGEBRA METHOD AND APPARATUS

(75) Inventor: Kazuhiro MATSUMOTO, Kawasaki (JP)

(73) Assignee: FUJITSU LIMITED, Kawasaki-shi (JP)

(21) Appl. No.: 12/940,117

(22) Filed: Nov. 5, 2010

(30) Foreign Application Priority Data
Nov. 11, 2009 (JP) 2009-257878

(51) Int. Cl. G06F 17/10

(52) U.S. Cl. 703/2

(57) ABSTRACT

A method includes: obtaining, for each of plural first sets predetermined input variable values, a second set of predetermined output variable values from a model to be investigated; generating plural approximate expressions representing relation between the input variables and the output variables by carrying out, plural times, a processing to calculate the approximate expression from the obtained data; calculating, for each of the plural approximate expressions, a feasible region for at least one of the predetermined input variables and the predetermined output variables; and generating display data to display the superimposed feasible regions for said plural approximate expressions, and outputting the display data to an output device.

### CROSS-REFERENCE TO RELATED APPLICATIONS

This application is based upon and claims the benefit of priority of the prior Japanese Patent Application No. 2009-257878, filed on Nov. 11, 2009, the entire contents of which are incorporated herein by reference.

### FIELD

This technique relates to an optimization technique by computer algebra.

### BACKGROUND

Recently, design optimization by computer simulation has been widely carried out. The design optimization by the computer simulation, which is frequently carried out at the present, is optimization by the numerical calculation. For example, as depicted in FIG. 1, it is assumed that the horizontal axis represents a cost, the vertical axis represents performance, and values nearer to the origin in both axis directions are preferable. Thus, by the computer simulation, a relation between the cost and the performance is obtained, and as depicted in FIG. 1, respective points can be plotted. Because, in FIG. 1, a point whose cost is low and whose performance is good is preferable, a point near to the origin is selected as the optimum point. However, because the results are obtained as discrete points, it is unclear whether or not there is a point, which can be realized, between points.

On the other hand, the design optimization by the computer simulation also includes an optimization method by the computer algebra. In such a method, the computer simulation is carried out for various input parameter values, and output evaluation indicators are calculated for respective cases. Then, an approximate expression “a” to approximate relations between the input parameters and the output evaluation indicators is calculated as depicted in FIG. 2, and the optimization by the computer algebra is carried out based on this approximate expression. There is a case where, as a processing for this optimization, an expression representing a relation between the cost and the performance, as depicted in FIG. 3, is calculated from the obtained approximate expression and restriction conditions. However, in a conventional art, there is a problem that the reliability is not considered, in spite of an approximate expression.

Incidentally, as for the computer algebra, a Quantifier Elimination (QE) method is known. This technique is a technique that an expression “∃x(x²+bx+c=0)”, for example, is changed to an equivalent expression “b²−4c≧0” by eliminating quantifiers such as ∃ and ∀.

Specifically, the QE method is described in the following document.

Jirstrand Mats, “Cylindrical Algebraic Decomposition—an Introduction”, Oct. 18, 1995.

This document is incorporated herein by reference.

However, because a lot of documents for the QE method exist, useful documents other than the following documents exist.

Anai Hirokazu and Yokoyama Kazuhiro, “Introduction to Computatinal Real Algebraic Geometry”, Mathematics Seminar, Nippon-Hyoron-sha Co., Ltd., “Series No. 1”, Vol. 554, pp. 64-70, November, 2007, “Series No. 2”, Vol. 555, pp. 75-81, December, 2007, “Series No. 3”, Vol. 556, pp. 76-83, January, 2008, “Series No. 4”, Vol. 558, pp. 79-85, March, 2008, “Series No. 5”, Vol. 559, pp. 82-89, April, 2008.

Anai Hirokazu, Kaneko Junji, Yanami Hitoshi and Iwane Hidenao, “Design Technology Based on Symbolic Computation”, FUJITSU, Vol. 60, No. 5, pp. 514-521, September, 2009.

In addition, the QE is a technique, which has been implemented in SyNRAC developed by Fujitsu Limited, for example.

As described above, the reliability of the approximate expression is not considered, and when the optimization is carried out based on the approximate expression without the reliability, problems occur.

Namely, in the conventional arts, no presentation is made for the reliability of the approximate expression obtained from the computer simulation.

### SUMMARY

A computer algebra method, comprising: (A) obtaining, for each of first sets stored in an input variable value storage device storing a plurality of first sets of predetermined input variable values, a second set of predetermined output variable values from a model to be investigated, and storing the predetermined output variable values obtained for a certain second set into a correspondence table in association with the predetermined input variable values for a certain first set corresponding to the certain second set; (B) reading out a predetermined number of records by sampling with replacement from said correspondence table, generating a plurality of approximate expressions representing a relation between the input variables and the output variables by carrying out, a plurality of times, a processing to calculate the approximate expression from the read records, and storing data of said plurality of approximate expressions into a storage device; (C) calculating, for each of said plurality of approximate expressions, which are stored in said storage device, a feasible region for at least one of the predetermined input variables and the predetermined output variables, and storing data of said feasible region into a feasible region storage device; and (D) generating display data to display the superimposed feasible regions for said plurality of approximate expressions, which are stored in said feasible region storage device, and outputting said display data to an output device.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an example of a processing result by numerical value calculation;

FIG. 2 is a diagram depicting an example of an approximate expression;

FIG. 3 is a diagram depicting an example of computer algebra;

FIG. 4 is a functional block diagram of a computer algebra apparatus;

FIG. 5 is a diagram depicting a main processing flow;

FIG. 6 is a diagram depicting an example of data stored in an input variable value storage;

FIG. 7 is a diagram depicting an example of an output variable value obtained from a simulator;

FIG. 8 is a diagram depicted an example of stored in a correspondence table;

FIG. 9 is a diagram depicting the main processing flow;

FIG. 10 is a diagram depicting an example of matrix display of the feasible regions;

FIG. 11 is a diagram depicting the main processing flow;

FIG. 12 is a diagram depicting an example of the feasible regions;

FIG. 13 is a diagram depicting an example of the feasible region display;

FIG. 14 is a functional block diagram of a computer;

FIG. 15 is a diagram depicting a processing flow of an embodiment;

FIG. 16 is a functional block diagram of a computer algebra apparatus in this embodiment;

FIG. 17 is a diagram to explain a processing of a QE processing unit;

FIG. 18 is a diagram to explain the processing of the QE processing unit;

FIG. 19 is a diagram to explain the processing of the QE processing unit;

FIG. 20 is a diagram to explain the processing of the QE processing unit;

FIG. 21 is a diagram to explain the processing of the QE processing unit;

FIG. 22 is a diagram to explain the processing of the QE processing unit;

FIG. 23 is a diagram to explain the processing of the QE processing unit;

FIG. 24 is a diagram to explain the processing of the QE processing unit;

FIG. 25 is a diagram to explain the processing of the QE processing unit;

FIG. 26 is a diagram to explain the processing of the QE processing unit;

FIG. 27 is a diagram to explain the processing of the QE processing unit; and

FIG. 28 is a diagram to explain the processing of the QE processing unit.

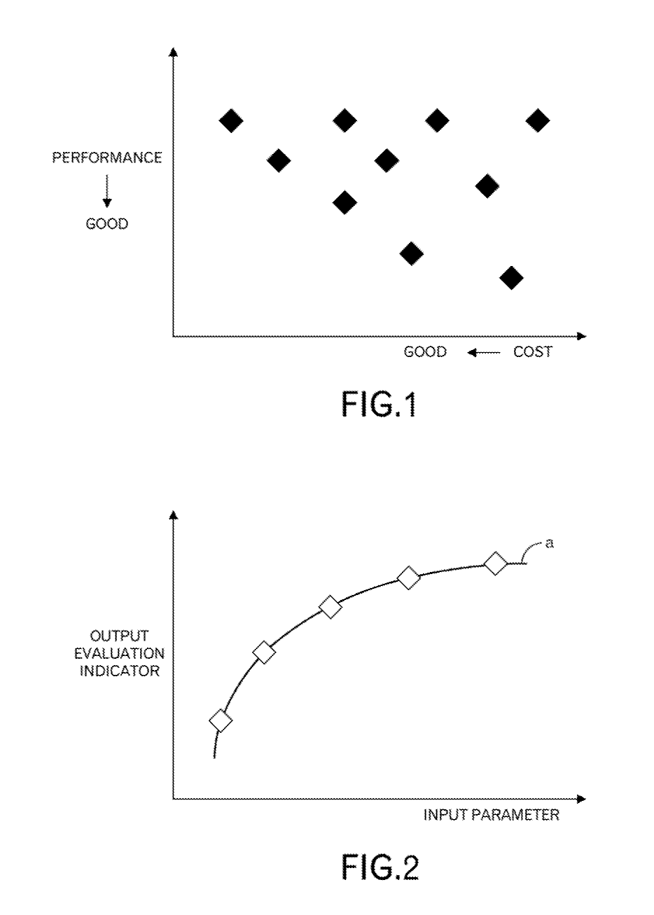

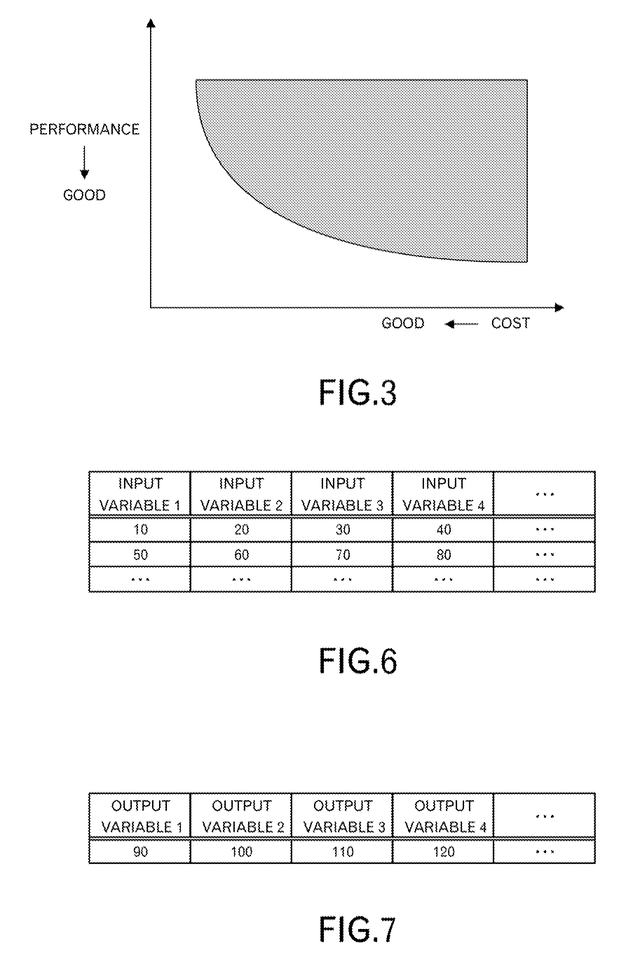

### DESCRIPTION OF EMBODIMENTS

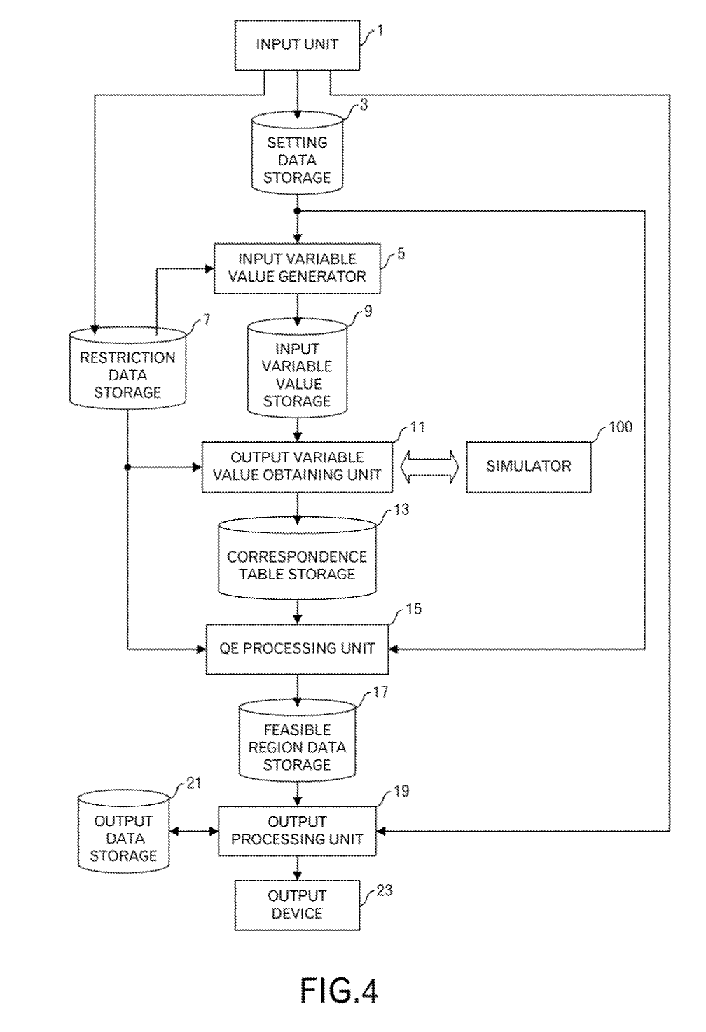

FIG. 4 depicts a functional block diagram of a computer algebra apparatus relating to this embodiment of this technique. The computer algebra apparatus has (A) an input unit 1 to accept inputs from a user, (B) a setting data storage 3 storing setting data obtained by the input unit 1, (C) a restriction data storage 7 storing restriction data obtained from the input unit 1, (D) an input variable value generator 5 to carry out a processing by using data stored in the setting data storage 3 and the restriction data storage 7, (E) an input variable value storage 9 storing processing results of the input variable value generator 5, (F) an output variable value obtaining unit 11 to carry out predetermined simulation for a simulator 100 by using data stored in the restriction data storage 7 and the input variable value storage 9, (G) a correspondence table storage 13 storing outputs of the output variable value obtaining unit 11, (H) a QE processing unit 15 to carry out a processing by using data stored in the setting data storage 3, the restriction data storage 7 and the correspondence table storage 13, (I) a feasible region data storage 17 storing processing results of the QE processing unit 15, (J) an output processing unit 19 carrying out a processing by using data stored in the feasible region data storage 17, (K) an output data storage 21 storing data used by an output processing unit 19; and (L) an output device 23 such as a display device or printer.

The output processing unit 19 may carry out a processing in response to an instruction from the input unit 1.

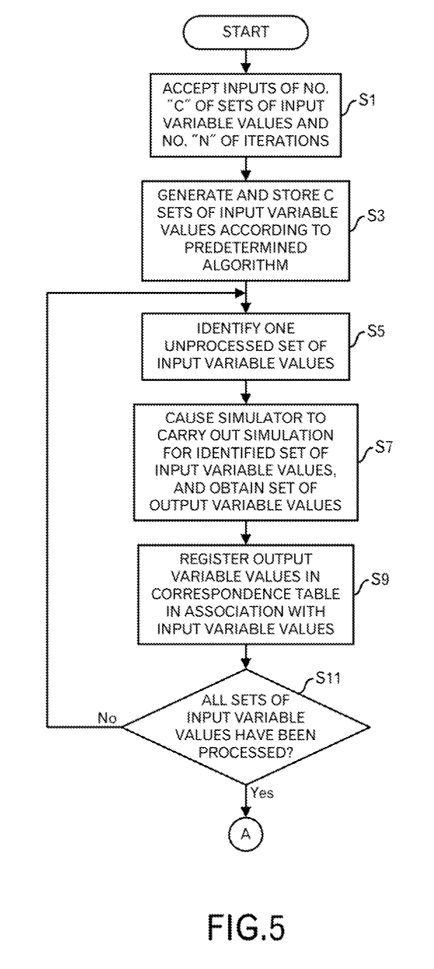

Next, processing contents of the computer algebra apparatus will be explained by using FIGS. 5 to 13. The input unit 1 prompts the user to input the number C of input variable values and the number N of iterations, accepts inputs of such data from the user, and stores the accepted data into the setting data storage 3 (step S1). Incidentally, the input unit 1 causes the user to also input the restriction data or accepts designation of a file including the restriction data from other computers connected with a network, obtains the restriction data and stores the restriction data into the restriction data storage 7. The restriction data includes restriction data for the input variables such as value ranges of the respective input variables, and restriction data to be given to the simulator 100.

Next, the input variable value generator 5 generates C sets of input variable values according to the restriction data stored in the restriction data storage 7 and a predetermined algorithm, and stores the generated data into the input variable value storage 9 (step S3). “C” is stored in the setting data storage 3. The predetermined algorithm includes well-known methods such as the design of experiments, the Latin hypercube sampling method, or the random sampling method. In addition, values are generated according to the restriction data for the input variable values, which is stored in the restriction data storage 7.

FIG. 6 depicts an example of data stored in the input variable value storage 9. In the example of FIG. 6, values are registered for the respective input variables . In addition, because C sets are generated, the number of records is “C”.

Then, the output variable value obtaining unit 11 identifies one set of input variable values stored in the input variable value storage 9 (step S5). After that, the output variable value obtaining unit 11 causes the simulator 100 to carryout simulation for the identified set of the input variable values, according to the restriction data stored in the restriction data storage 7, and obtains a set of output variable values, as the result of the simulation, from the simulator 100 (step S7). For example, as depicted in FIG. 7, the respective output variable values are obtained from the simulator 100.

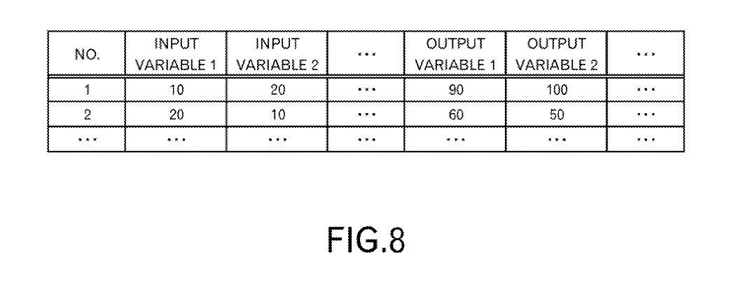

Then, the output variable value obtaining unit 11 registers the set of output variable values obtained from the simulator 100 into the correspondence table stored in the correspondence table storage 13 in association with the set of input variable values identified at the step S5 (step S 9). The correspondence table as depicted in FIG. 8 is stored into the correspondence table storage 13. Namely, the respective records include the respective input variable values and respective corresponding output variable values.

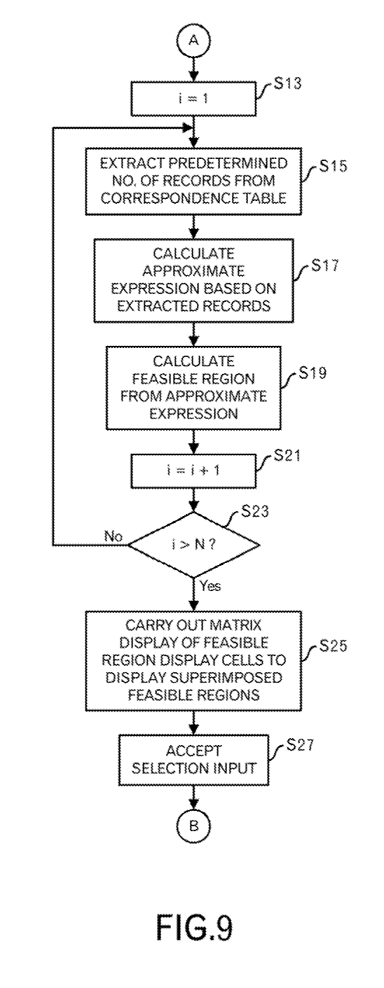

Then, the output variable value obtaining unit 11 judges whether or not all of sets of input variable values, which are stored in the input variable value storage 9, have been processed (step S11). When there is an unprocessed set, the processing shifts to the step S5. On the other hand, when all sets have been processed, the processing shifts to a processing in FIG. 9 through a terminal A.

Shifting to the explanation of the processing in FIG. 9, the QE processing unit 15 initializes a counter “i” to “1” (step S13). Then, the QE processing unit 15 extracts a predetermined number of records by the sampling with replacement, from the correspondence table stored in the correspondence table storage 13 (step S15). More specifically, a predetermined number of records less than the number of records in the correspondence table are randomly extracted.

Then, the QE processing unit 15 calculates an approximate expression by a known method (e.g. the least squares method or the like) based on the extracted data, and stores data of the calculated approximate expression into the feasible region data storage 17 (step S17). For example, a, b and c are calculated in a form of an expression “output variable 1=a*input variable 1+b*input variable 2+c”. Data representing what input variables are associated with what output variables in one approximate expression is stored as the restriction data stored in the restriction data storage 7, and the approximate expression is calculated according to such data. Plural approximate expression maybe derived from the extracted data.

Moreover, the QE processing unit 15 calculates a feasible region (specifically, an expression) for each of the input variables and output variables in the approximate expression from the approximate expression obtained at the step S17 and the restriction data (e.g. value range data or the like) stored in the restriction data storage 7, and stores data for the feasible region into a feasible region data storage 17 (step S19). For example, when the approximate expression “x²+bx+c=0” described in the background art is obtained, a condition that x can exist is “b²−4c≧0” obtained by the quantifier elimination method. Such a condition represents the feasible region of “x”. Namely, by applying the known quantifier elimination method, at the step S19, to the approximate expression obtained at the step S17, the feasible region is obtained. Incidentally, three variables exist in the aforementioned approximate expression, the feasible region of “x” is described by “b” and “c” as described above. The feasible region of “b” is described by “x” and “c”, and the feasible region of “c” is described by “x” and “b”. Thus, the feasible region of the respective input variables and output variables can be calculated by the quantifier elimination method. Incidentally, as for the calculation modes of the feasible region, “b” and “c” are designated in the aforementioned example to calculate the feasible region of “x”. Namely, all feasible regions of a certain variable, which are described by a combination of the input variables and output variables, which are other than the certain variable, may be calculated.

After that, the QE processing unit 15 increments the value of the counter “i” by “1” (step S21), and judges whether or not “i” exceeds N stored in the setting data storage 3 (step S23). When “i” equal to or less than N, the processing returns to the step S15.

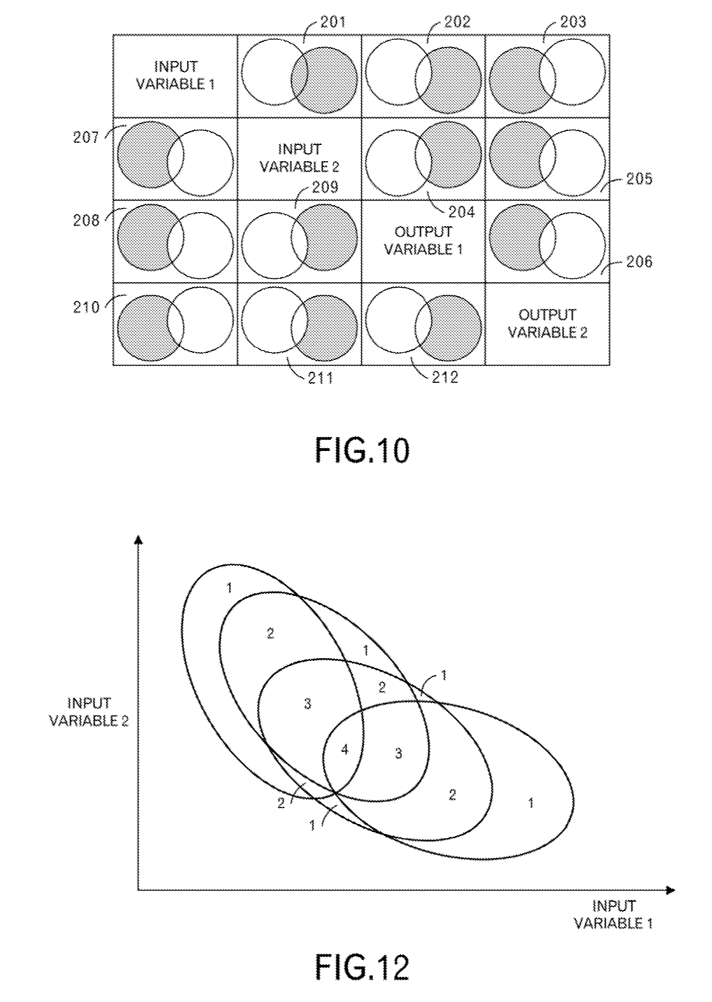

On the other hand, when “i” exceeds “N”, the output processing unit 19 carries out matrix display of the feasible regions, in which the calculated feasible regions are superimposed, by using data of the feasible regions, which is stored in the feasible region data storage 17, to the output device 23 (step S25). For example, display as depicted in FIG. 10 is made.

FIG. 10 depicts an example of the matrix display in case where, approximate expressions are described by the input variables 1 and 2 and the output variables 1 and 2, and two approximate expressions (or two sets of approximate expressions) are obtained. The feasible region display cells 201 and 207 in FIG. 10 represent a plane mapped by the input variables 1 and 2, and a state is displayed that the feasible regions (circles in FIG. 10) corresponding to the approximate expressions are superimposed. Similarly, the feasible region display cells 202 and 208 represent a plane mapped by the input variable 1 and the output variable 1, and a state is displayed that the feasible regions corresponding to the approximate expressions are superimposed. The feasible region display cells 203 and 210 represent a plane mapped by the input variable 1 and the output variable 2, and a state is displayed that the feasible regions corresponding to the approximate expressions are superimposed. The feasible region display cells 204 and 209 represent a plane mapped by the input variable 2 and the output variable 1, and a state is displayed that the feasible regions corresponding to the approximate expressions are superimposed. The feasible region display cells 205 and 211 represent a plane mapped by the input variable 2 and the output variable 2, and a state is displayed that the feasible regions corresponding to the approximate expressions are superimposed. The feasible region display cells 206 and 212 represent a plane mapped by the output variable 1 and the output variable 2, and a state is displayed that the feasible regions corresponding to the approximate expressions are superimposed.

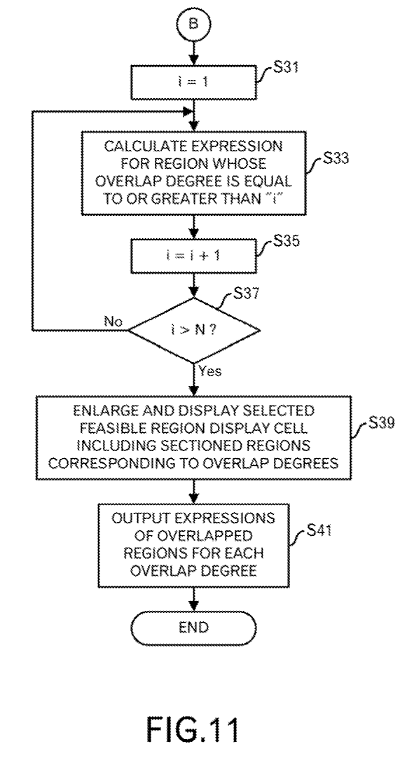

The user watches such display, and judges which feasible region display cell is specifically considered, and selects any cell in the matrix. The input unit 1 accepts selection input from the user, and notifies the output processing unit 19 which cell is selected (step S27). The output processing unit 19 identified the selected cell. The processing shifts to a processing in FIG. 11 through a terminal B.

Shifting to the explanation of a processing in FIG. 11, the output processing unit 19 initializes the counter “i” by “1” (step S31), calculates an expression for a region whose overlap degree is equal to or greater than “i” by using the feasible regions relating to the selected feasible region display cell, and stores the calculated expression into the output data storage 21 (step S33). Incidentally, although an example in which “i” is sequentially incremented from “1” is indicated, an expression for the region whose overlap degree is only a designated value or whose overlap degree is equal to or greater than the designated value may be calculated.

For example, there are three kinds of approximate expressions, and they are denoted as expressions 1, 2 and 3. In such a case, the region whose overlap degree is equal to “1” is represented by (expression 1) OR (expression 2) OR (expression 3). In addition, the region whose overlap degree is equal to “2” is represented by {(expression 1) AND (expression 2)} OR {(expression 2) AND (expression 3) } OR {(expression 1) AND (expression 3)}. The region whose overlap degree is equal to “3” is represented by (expression 1) AND (expression 2) AND (expression 3). Thus, for each overlap degree, the expression for the region is generated by combining the expressions by “AND” and/or “OR”. Incidentally, this technical matter is also described in the documents about QE, which are listed as the background arts.

Then, the output processing unit 19 increments “i” by “1” (step S35), and judges whether or not “i” exceeds N (step S37). When “i” is equal to or less than N, the processing returns to the step S33. On the other hand, when “i” exceeds N, the output processing unit 19 enlarges and displays the selected feasible region display cell including sectioned regions (also called “sub-area”) corresponding to the overlap degrees to the output device 23 (step S39). For example, display as depicted in FIG. 12 may be carried out. In FIG. 12, two input variables and 4 approximate expressions exist, and 4 curves representing the 4 feasible regions are displayed. Then, because those feasible regions are dislocated, plural sub-areas whose overlap degree is different can be grasped. At this step, display data to display the overlap degree in the region corresponding to the expression of each overlap degree, which was calculated at the step S33, is generated. Because the 4 feasible regions exist, the regions whose overlap degree is equal to “1” to “4” exist.

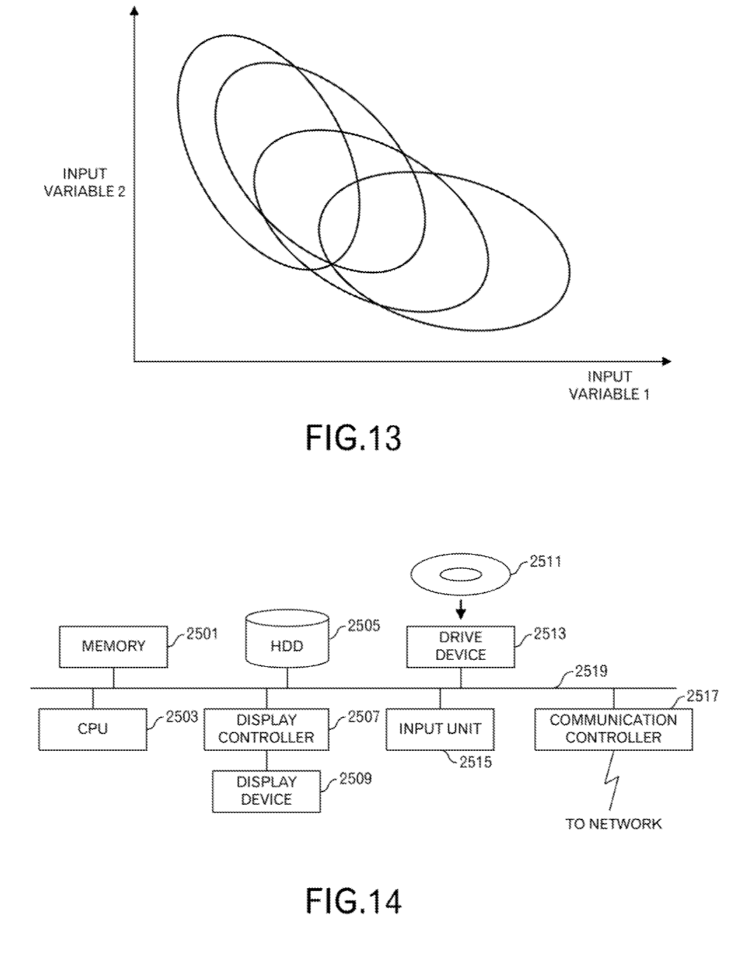

Incidentally, after, as depicted in FIG. 13, simply displaying the duplication state of the feasible regions, the display depicted in FIG. 12 may be displayed in response to the user's instruction.

In addition, the region for which the overlap degree is displayed may be limited to only one or more regions, such as only a region having the maximum overlap degree, regions whose overlap degree is equal to or greater than a predetermined value, or region whose overlap degree is a designated value .

Furthermore, the output processing unit 19 outputs to the display device 23, an expression of the overlapped area stored in the output data storage 21 and calculated for each overlap degree (step S41). When the user clicks a specific sub-area, the expression for the clicked sub-area may be displayed.

For example, it is assumed that the feasible region of the approximate expression 1 is represented by (input variable 1≦10) AND (input variable 1≦30) AND (input variable 2≧50) AND (input variable 2≦70), and the feasible region of the approximate expression 2 is represented by (input variable 1≧20) AND (input variable 1≦40) AND (input variable 2≧60) AND (input variable 2≦80). Then, the sub-area whose overlap degree is equal to or greater than 2 is represented by “(input variable 1≧20) AND (input variable 1≦30), or (input variable 2≧60) AND (input variable 2≦70)”. In addition, the sub-area whose overlap degree is equal to or greater than 1 is represented by “(input variable 1≧10) AND (input variable 1≦30) AND (input variable 2≧50) AND (input variable 2≦70)” or “(input variable 1≧20) AND (input variable 1≦40) AND (input variable 2≧60) AND (input variable 2≦80)”.

Typically, it is assumed that the reliability is high for the region whose overlap degree is high, and the reliability is low for the region whose overlap degree is low. Therefore, when the reliability is low, a case may exist that cannot be realized. By carrying out such display, it becomes possible to easily judge what region is preferable and/or what overlap degree is preferable.

Although the embodiment is explained above, this technique is not limited to this embodiment. For example, the functional block diagram of the computer algebra apparatus depicted in FIG. 4 is a mere example, and does not always correspond to an actual program module configuration. In addition, the processing flow can be changed so as to change the order of the steps or execute the steps in parallel, as long as the processing results do not change. For example, the feasible region for the designated variables maybe displayed from the first without carrying out the matrix display.

In addition, it is possible to adopt various display modes, and display in the 3 dimensional space, not 2 dimensional space, may be carried out.

In addition, although an example was explained that the computer algebra apparatus is implemented by a stand-alone type computer, the aforementioned processing may be executed by plural computers connected to the computer network and cooperating with each other.

In addition, the computer algebra apparatus is a computer device as shown in FIG. 14. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 14. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

[Specific Example of a Method for Calculating the Feasible Region]

In the following, a specific example of a calculation processing of the feasible region, which is carried out by the QE processing unit 15, will be explained.

First, it is assumed that the input variables are X and Y, the output variable is Z, the approximate expression representing the relation between the input and the output is represented by “Z=X²+Y²−1”. Furthermore, it is assumed that the restriction condition is represented by “Z<0 AND X³−Y²=0”.

(1) Calculation Step 1

(1-1) Set functions F and G as follows:

F(X, Y)=X²+Y²−1

G(X, Y)=X³−Y²

(1-2) Calculate function F(X, 0)=0 X=−1, 1

(1-3) Calculate function G(X, 0)=0 X=0

(1-4) Calculate F(X, Y)=G(X, Y) for X

Namely, transform the expression so as to delete terms of Y². Then, a following expression is obtained.

X³+X²−1=0

Therefore, it is assumed that a value of X, which satisfies this expression, is A. X=A

(2) Calculation Step 2

(2-1) Put values of X, which were calculated in the calculation step 1 in order

X={−1, 0, A, 1}

(2-2) Add a value less than the minimum value of X, values between calculated values of X and a value greater than the maximum value.

X={X1, X2=−1, X3, X4=0, X5, X6=A, X7, X8=1, X9}

(3) Calculation Step 3

Calculate Y satisfying a condition of F(X, Y)=0 or G(X, Y)=0 for each value of X.

X=X1: none

X=X2: Y={Y21=0}

X=X3: Y={Y31, Y32}

X=X4: Y={Y41=−1, Y42=0, Y43=1}

X=X5: Y={Y51, Y52, Y53, Y54}

X=X6: Y={Y61=−A^{3/2}, Y62=A^{3/2}}

X=X7: Y={Y71, Y72, Y73, Y74}

X=X8: Y={Y81=−1, Y82=0, Y83=1}

X=X9: Y={Y91, Y92}

(4) Calculation Step 4

Add a value less than the minimum value of Y, values between calculated values of Y and a value greater than the maximum value of Y. When there is no value, “0” is set.

X=X1: Y={YY11=0}

X=X2: Y={YY21, YY22=Y21, YY23}

X=X3: Y={YY31, YY32=Y31, YY33, YY34=Y32, YY35}

X=X4: Y={YY41, YY42=Y41, YY43, YY44=Y42, YY45, YY46=Y43, YY47}

X=X5: Y={YY51, YY52=Y51, YY53, YY54=Y52, YY55, YY56=Y53, YY57, YY58=Y54, YY59}

X=X6: Y={YY61, YY62=Y61, YY63, YY64=Y62, YY65}

X=X7: Y={YY71, YY72=Y71, YY73, YY74=Y72, YY75, YY76=Y73, YY77, YY78=Y74, YY79}

X=X8: Y={YY81, YY82=Y81, YY83, YY84=Y82, YY85, YY86=Y83, YY87}

X=X9: Y={YY91, YY92=Y91, YY93, YY94=Y92, YY95}

(5) Calculation Step 5

(5-1) Calculate a sign of F(X, Y) and G(X, Y) for each combination of X and Y, which are calculated at the calculation step 4.

(X, Y)=(X1, YY11) −>(F, G)=(+, −)

Carry out such calculation for all combinations.

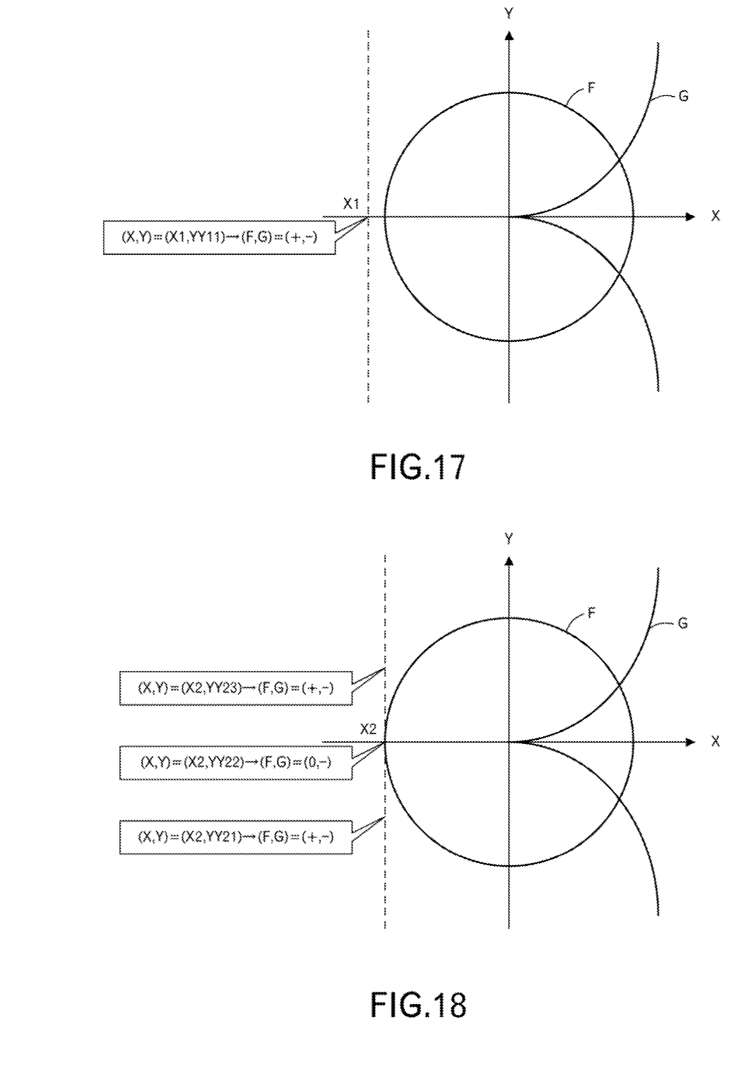

As depicted in FIG. 17, in a plane XY, F(X, Y)=0 represents a circle whose radius is “1” and whose center is the origin, and G(X, Y)=0 represents a curve depicted by “G”. X1 is a value less than “−1”, and X=X1 represents a straight line represented by a dotted line. Because of YY11=0, a cross point of X=X1 and Y=0 is a point (X1, YY11). According to the definition of F and G, (F, G)=(+, −).

Furthermore, FIG. 18 depicts a state at X=X2=−1. Because of X2=−1, X=X2 is a straight line, which comes in contact with F(X, Y)=0. Then, YY22=0 and YY21 is a positive value. Therefore, YY23 is a negative value. From this point, a following calculation result is obtained.

(X, Y)=(X2, YY23)−>(F, G)=(+, −)

(X, Y)=(X2, YY22)−>(F, G)=(0, −)

(X, Y)=(X2, YY21)−>(F, G)=(+, −)

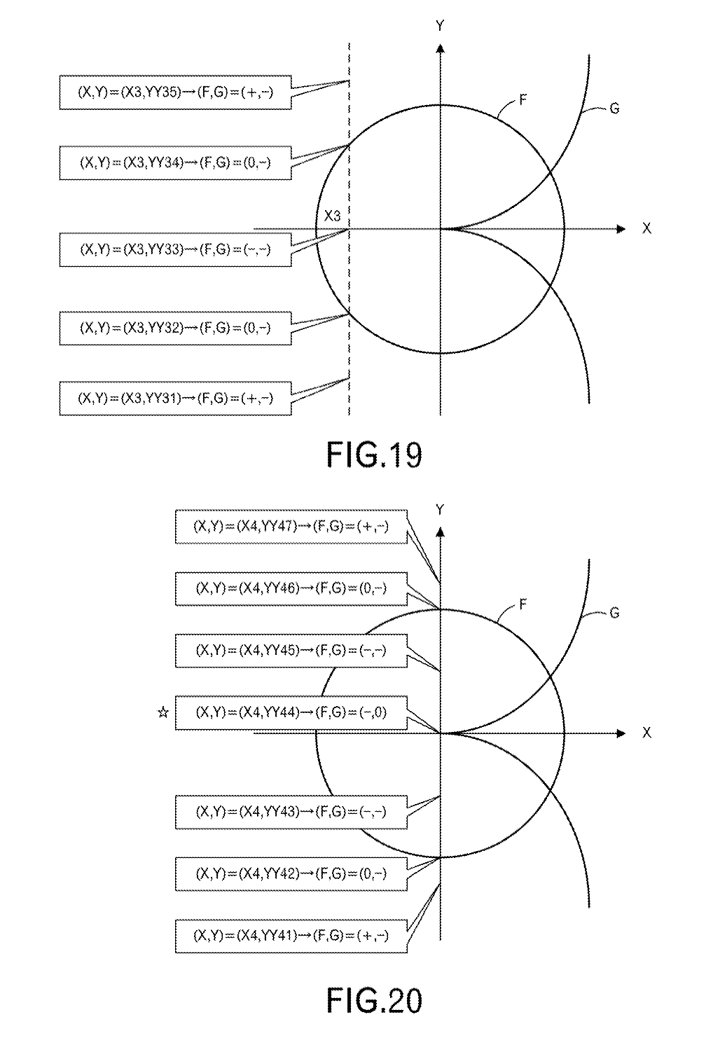

In addition, FIG. 19 depicts a state at X=X3. X3 is a value greater than “−1” and less than “0” . On the other hand, YY32=Y31 and YY34=Y32 . Therefore, Y31 and Y32 are points on F (X, Y)=0. In addition, YY33=0 is assumed. Furthermore, because YY35 is a value greater than YY34, YY31 is a value less than YY32. Then, following calculation results are obtained.

(X, Y)=(X3, YY35)−>(F, G)=(+, −)

(X, Y)=(X3, YY34)−>(F, G)=(0, −)

(X, Y)=(X3, YY33)−>(F, G)=(+, −)

(X, Y)=(X3, YY32)−>(F, G)=(0, −)

(X, Y)=(X3, YY31)−>(F, G)=(+, −)

Furthermore, FIG. 20 depicts a state at X=X4=0. YY42=Y41=−1, YY44=Y42=0 and YY46=Y43=1. Therefore, YY41 is a value less than “−1”, YY43 is a value greater than “−1” and less than “0”, YY45 is a value greater than “0” and less than “1”, and YY47 is a value greater than “1”. Then, following calculation results are obtained.

(X, Y)=(X4, YY47)−>(F, G)=(+, −)

(X, Y)=(X4, YY46)−>(F, G)=(0, −)

(X, Y)=(X4, YY45)−>(F, G)=(−, −)

(X, Y)=(X4, YY44)−>(F, G)=(−, 0)

(X, Y)=(X4, YY43)−>(F, G)=(−, −)

(X, Y)=(X4, YY42)−>(F, G)=(0, −)

(X, Y)=(X4, YY41)−>(F, G)=(+, −)

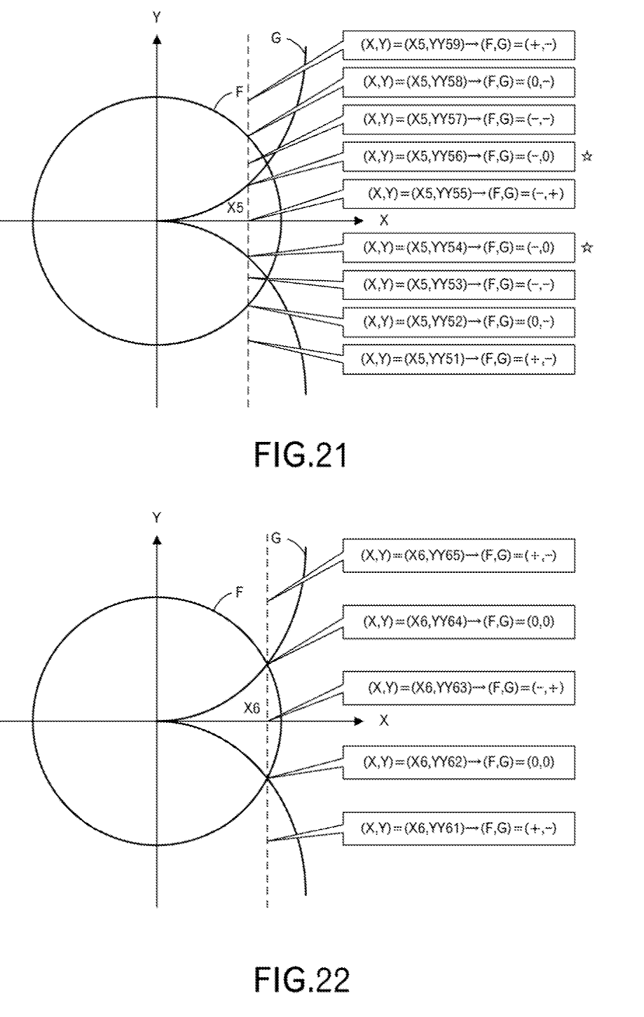

In addition, FIG. 21 depicts a state at X=X5. X5 is a value greater than “0” and less than A of X, which satisfies “X³+X²−1=0”. Furthermore, Y51, Y52, Y53 and Y54 are values satisfying F(X, Y)=0 or G(X, Y)=0, and YY52=Y51, YY54=Y52, YY56=Y53 and YY58=Y54. Therefore, (X5, YY52) is a point whose Y is a negative value among cross points of F(X, Y)=0 and X=X5. (X5, YY54) is a point whose Y is a negative value among cross points of G(X, Y)=0 and X=X5. (X5, YY56) is a point whose Y is a positive value among cross points of G(X, Y)=0 and X=X5. (X5, YY58) is a point whose Y is a positive value among cross points of F(X, Y)=0 and X=X5. Furthermore, YY55 is a point between YY56 and YY54. However, YY55=0 is assumed, here. Incidentally, YY51 is a value less than YY52, and YY59 is a value greater than YY58. Then, following calculation results are obtained.

(X, Y)=(X5, YY59)−>(F, G)=(+, −)

(X, Y)=(X5, YY58)−>(F, G)=(0, −)

(X, Y)=(X5, YY57)−>(F, G)=(−, −)

(X, Y)=(X5, YY56)−>(F, G)=(−, 0)

(X, Y)=(X5, YY55)−>(F, G)=(−, +)

(X, Y)=(X5, YY54)−>(F, G)=(−, 0)

(X, Y)=(X5, YY53)−>(F, G)=(−, −)

(X, Y)=(X5, YY52)−>(F, G)=(0, −)

(X, Y)=(X5, YY51)−>(F, G)=(+, −)

In addition, FIG. 22 depicts a state at X=X6. X6 is a value A of X, which satisfies “X³+X²−1=0”. Namely, X=X6 is a straight line passing through a cross point of F(X, Y)=0 and G(X, Y)=0. Incidentally, YY62=Y61=−A^{3/2}, YY64=Y62=A^{3/2}. (X6, YY62) corresponds to a point whose Y is a negative value among cross points of F(X, Y)=0 and G(X, Y)=0, and (X6, YY64) corresponds to a point whose Y is a positive value among cross points of F(X, Y)=0 and G(X, Y)=0. YY63 is a value between YY62 and YY64. However, YY63=0 is assumed. YY65 is a value greater than YY64 and YY61 is a value less than YY62. Then, following calculation results are obtained.

(X, Y)=(X6, YY65)−>(F, G)=(+, −)

(X, Y)=(X6, YY64)−>(F, G)=(0, 0)

(X, Y)=(X6, YY63)−>(F, G)=(−, +)

(X, Y)=(X6, YY62)−>(F, G)=(0, 0)

(X, Y)=(X6, YY61)−>(F, G)=(+, −)

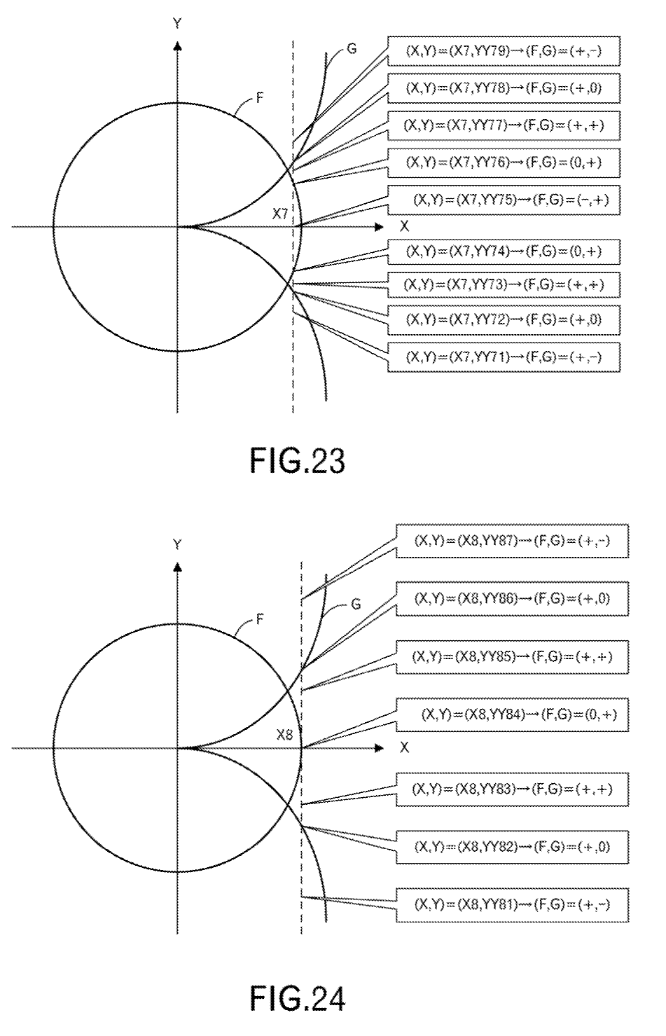

Furthermore, FIG. 23 depicts a state at X=X7. X7 is a value between X6 and X=1. In addition, (X7, YY72=Y71) is a point whose Y is a negative value among cross points of X=X7 and G(X, Y)=0. (X7, YY74=Y72) is a point whose Y is a negative value among cross points of X=X7 and F(X, Y)−0. (X7, YY76=Y73) is a point whose Y is a positive value among cross points of X=X7 and F(X, Y)=0. (X7, YY78=Y74) is a point whose Y is a positive value among X=X7 and G(X, Y)=0. YY71 is a value less than YY72, YY73 is a value between YY72 and YY74, YY75 is a value between YY74 and YY76. However, YY75=0, here. In addition, YY77 is a value between YY76 and YY78, and YY79 is a value greater than YY78. Then, following calculation results are obtained.

(X, Y)=(X7, YY79)−>(F, G)=(+, −)

(X, Y)=(X7, YY78)−>(F, G)=(+, 0)

(X, Y)=(X7, YY77)−>(F, G)=(+, +)

(X, Y)=(X7, YY76)−>(F, G)=(0, +)

(X, Y)=(X7, YY75)−>(F, G)=(−, +)

(X, Y)=(X7, YY74)−>(F, G)=(0, +)

(X, Y)=(X7, YY73)−>(F, G)=(+, +)

(X, Y)=(X7, YY72)−>(F, G)=(+, 0)

(X, Y)=(X7, YY71)−>(F, G)=(+, −)

In addition, FIG. 24 depicts a state at X=X8=1. YY82=Y81=−1, YY84=Y82=0, and YY86=Y83=1. Therefore, YY81 is a value less than “−1”, YY83 is a value greater than “−1” and less than “0”, YY85 is a value greater than “0” and less than “1”, and YY87 is a value greater than “1”. Then, following calculation results are obtained.

(X, Y)=(X8, YY87)−>(F, G)=(+, −)

(X, Y)=(X8, YY86)−>(F, G)=(+, 0)

(X, Y)=(X8, YY85)−>(F, G)=(+, +)

(X, Y)=(X8, YY84)−>(F, G)=(0, +)

(X, Y)=(X8, YY83)−>(F, G)=(+, +)

(X, Y)=(X8, YY82)−>(F, G)=(+, 0)

(X, Y)=(X8, YY81)−>(F, G)=(+, −)

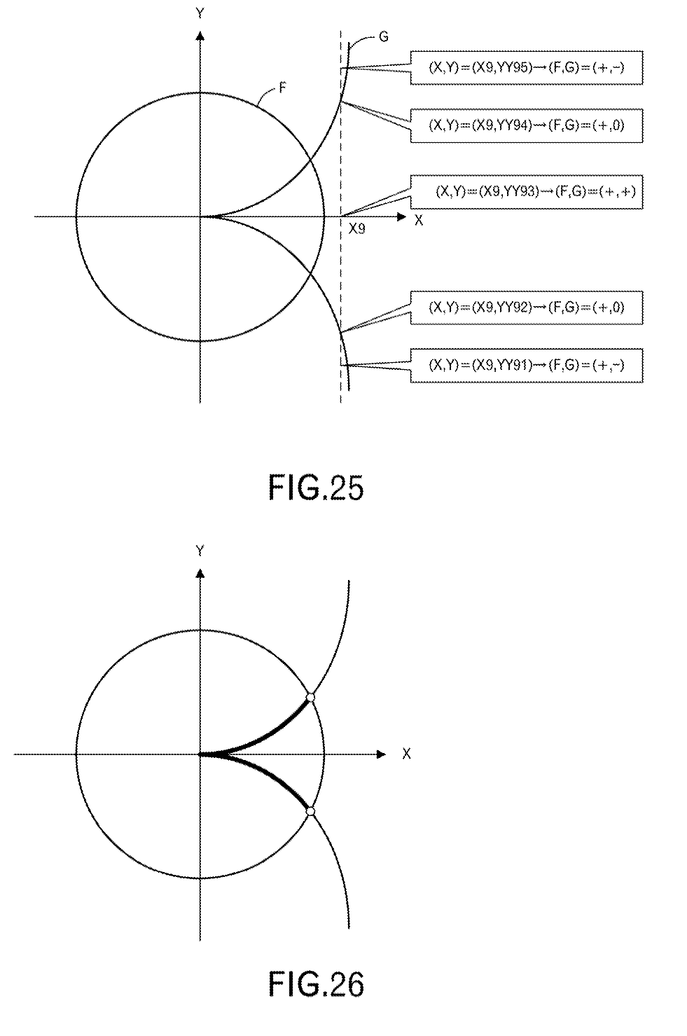

Furthermore, FIG. 25 depicts a state at X=X9>1. (X9, YY92=Y91) is a point whose Y is a negative value among cross points of X=X9 and G(X, Y)=0. (X9, YY94=Y92) is a point whose Y is a positive value among cross points X=X9 and G(X, Y)=0. In addition, YY91 is a value less than YY92, and YY95 is a value greater than YY94. YY93 is a point between YY92 and YY94. However, YY93=0 is assumed, here. Then, following calculation results are obtained.

(X, Y)=(X9, YY95)−>(F, G)=(+, −)

(X, Y)=(X9, YY94)−>(F, G)=(+, 0)

(X, Y)=(X9, YY93)−>(F, G)=(+, +)

(X, Y)=(X9, YY92)−>(F, G)=(+, 0)

(X, Y)=(X9, YY91)−>(F, G)=(+, −)

(5-2) Select Points Satisfying (F, G)=(−, 0)

This is because the restriction condition includes G(X, Y)=0 and F(X, Y)=Z<0. (X, Y)=(X4, YY44), (X5, YY54), (X5, YY56).

(6) Calculation Step 6

(6-1) Calculate Conditions Satisfying (X, Y)=(X4, YY44)

As you can understand from FIG. 20 and the aforementioned explanation, (X, Y)=(X4, YY44)=(0, 0) is satisfied.

(6-2) Calculate Conditions Satisfying (X, Y)=(X5, YY54)

As you can understand from FIG. 21 and the aforementioned explanation, X5 satisfies 0<X<A. In addition Y<YY55=0. Furthermore, because the solutions are points on G(X, Y)=0, X³−Y²=0.

(6-3) Calculate Conditions Satisfying (X, Y)=(X5, YY56)

As you can understand from FIG. 21 and the aforementioned explanation, X5 satisfies 0<X<A. In addition, Y>YY5. Furthermore, because the solutions are points on G(X, Y)=0, X³−Y²=0.

(7) Calculation Step 7

Put conditions, which was calculated at the calculation step 6 and satisfies (X, Y)=(X5, YY54) or (X, Y)=(X5, YY56) in order. In this example, because there is (X, Y)=(X4, Y44), (X, Y)=(0, 0) is included. Therefore, X³−Y²=0 AND 0≦X<A is obtained. Namely, as depicted in FIG. 26, a portion on the curve G(X, Y)=0 is a feasible region.

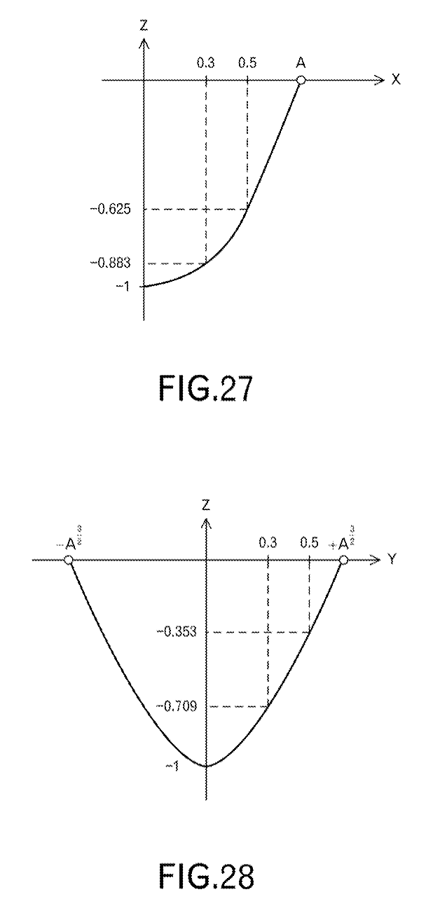

Incidentally, FIG. 26 depicts the feasible region of Z by a combination of X and Y. Namely, it is the feasible region of Z. Then, the aforementioned conditions can be solved for a combination of X and Z and a combination of Y and Z. Specifically, the feasible region of Y for the combination of X and Z can be obtained as a curve as depicted in FIG. 27. Similarly, the feasible region of X for the combination of Y and Z can be obtained as a curve as depicted in FIG. 28.

The embodiment is outlined as follows:

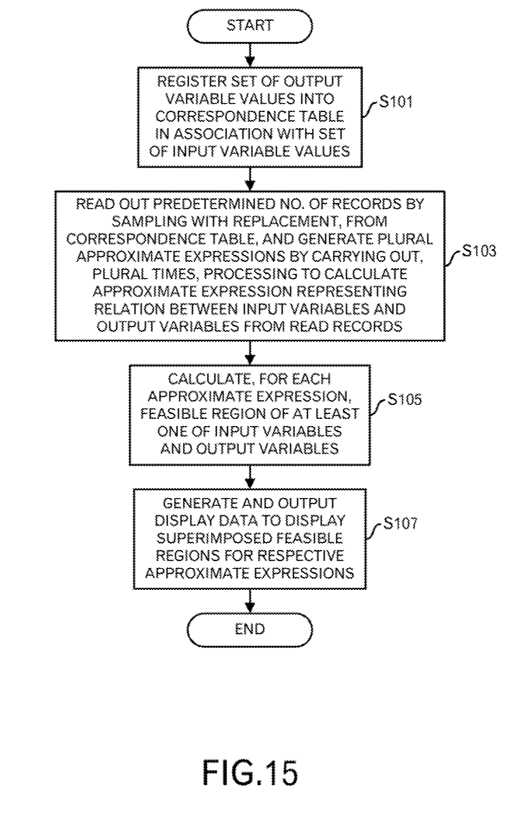

A computer algebra method (FIG. 15) relating to the embodiment includes: (A) [step S101] obtaining, for each of first sets stored in an input variable value storage device storing a plurality of first sets of predetermined input variable values, a second set of predetermined output variable values from a model to be investigated, and storing the predetermined output variable values obtained for a certain second set into a correspondence table in association with the predetermined input variable values for a certain first set corresponding to the certain second set; (B) [step S103] reading out a predetermined number of records by sampling with replacement from the correspondence table, generating a plurality of approximate expressions representing a relation between the input variables and the output variables by carrying out, a plurality of times, a processing to calculate the approximate expression from the read records, and storing data of the plurality of approximate expressions into a storage device; (C) [step S105] calculating, for each of the plurality of approximate expressions, which are stored in said storage device, a feasible region for at least one of the predetermined input variables and the predetermined output variables, and storing data of the feasible region into a feasible region storage device; and (D) [step S107] generating display data to display the superimposed feasible regions for the plurality of approximate expressions, which are stored in the feasible region storage device, and outputting the display data to an output device.

Thus, the reliability of the approximate expressions can be evaluated from the overlap degrees of the feasible regions. More specifically, it becomes possible to adopt preferable input variable values from the feasible region having high overlap degree.

In addition, the computer algebra method further may include: calculating an expression defining a sub-area having a overlap degree that is equal to or greater than a predetermined value, in all of the feasible regions for a certain variable among the predetermined input variables and the predetermined output variables, and storing data of the calculated expression into an output data storage device; and outputting the data of the calculated expression to the output device. The predetermined value maybe “1”, the maximum value or a value designated by the user, for example.

Furthermore, the outputting may include: identifying a sub-area having each of overlap degrees, a sub-area having a greatest overlap degree or a sub-area having a certain overlap degree in all of the feasible regions for a certain variable among the predetermined input variables and the predetermined output variables, and generating data to display a corresponding overlap degree in association with the identified sub-area. Thus, it becomes easy to understand noticeable areas.

In addition, the calculating may include: calculating, for each of the plurality of approximate expressions, feasible regions in a plurality of spaces for a plurality of combinations of the predetermined input variables and the predetermined output variables, and the outputting may include generating display data for each of the plurality of spaces. Thus, it becomes possible to identify a combination of characteristic variables.

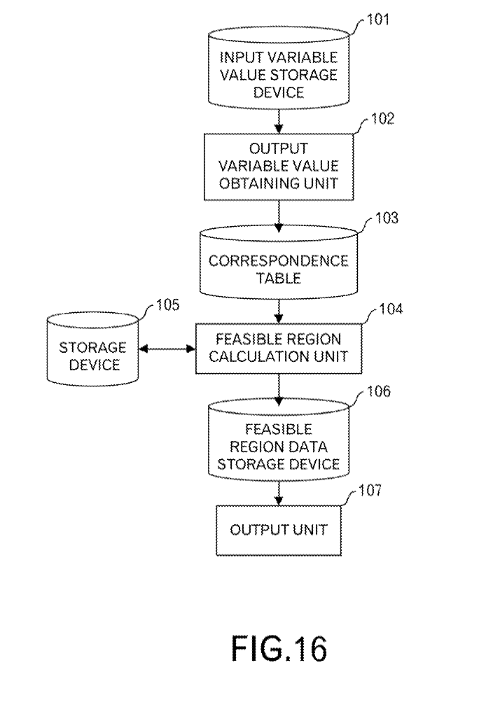

A computer algebra apparatus (FIG. 16) includes: an output variable value obtaining unit (102) to obtain, for each of first sets stored in an input variable value storage device (101) storing a plurality of first sets of predetermined input variable values, a second set of predetermined output variable values from a model to be investigated, and to store the predetermined output variable values obtained for a certain second set into a correspondence table (103) in association with the predetermined input variable values for a certain first set corresponding to the certain second set; a feasible region calculation unit (104) to read out a predetermined number of records by sampling with replacement from said correspondence table, to generate a plurality of approximate expressions representing a relation between the input variables and the output variables by carrying out, a plurality of times, a processing to calculate the approximate expression from the read records, and storing data of the plurality of approximate expressions into a storage device (105), and to calculate, for each of the plurality of approximate expressions, which are stored in the storage device, a feasible region for at least one of the predetermined input variables and the predetermined output variables, and to store data of the feasible region into a feasible region data storage device (106) ; and an output unit (107) to generate display data to display the superimposed feasible regions for said plurality of approximate expressions, which are stored in the feasible region storage device, and to output said display data to an output device.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable storage medium storing a program for causing a computer to execute a computer algebra process, comprising:
obtaining, for each of first sets stored in an input variable value storage device storing a plurality of first sets of predetermined input variable values, a second set of predetermined output variable values from a model to be investigated, and storing the predetermined output variable values obtained for a certain second set into a correspondence table in association with the predetermined input variable values for a certain first set corresponding to the certain second set;
reading out a predetermined number of records by sampling with replacement from said correspondence table, generating a plurality of approximate expressions representing a relation between the input variables and the output variables by carrying out, a plurality of times, a processing to calculate the approximate expression from the read records, and storing data of said plurality of approximate expressions into a storage device;
calculating, for each of said plurality of approximate expressions, which are stored in said storage device, a feasible region for at least one of the predetermined input variables and the predetermined output variables, and storing data of said feasible region into a feasible region storage device; and
generating display data to display the superimposed feasible regions for said plurality of approximate expressions, which are stored in said feasible region storage device, and outputting said display data to an output device.

2. The non-transitory computer-readable storage medium as set forth in claim 1, wherein said computer algebra process further comprises:
calculating an expression defining a sub-area having a overlap degree that is equal to or greater than a predetermined value, in all of said feasible regions for a certain variable among said predetermined input variables and said predetermined output variables, and storing data of the calculated expression into an output data storage device; and
outputting said data of the calculated expression to said output device.

3. The non-transitory computer-readable storage medium as set forth in claim 1, wherein said outputting comprises:
identifying a sub-area having each of overlap degrees, a sub-area having a greatest overlap degree or a sub-area having a certain overlap degree in all of said feasible regions for a certain variable among said predetermined input variables and said predetermined output variables, and generating data to display a corresponding overlap degree in association with said identified sub-area.

4. The non-transitory computer-readable storage medium as set forth in claim 1, wherein said calculating comprises calculating, for each of said plurality of approximate expressions, feasible regions in a plurality of spaces for a plurality of combinations of said predetermined input variables and said predetermined output variables, and said outputting comprises generating display data for each of said plurality of spaces.

5. A computer algebra apparatus, comprising:
an output variable value obtaining unit to obtain, for each of first sets stored in an input variable value storage device storing a plurality of first sets of predetermined input variable values, a second set of predetermined output variable values from a model to be investigated, and to store the predetermined output variable values obtained for a certain second set into a correspondence table in association with the predetermined input variable values for a certain first set corresponding to the certain second set;
a feasible region calculation unit to readout a predetermined number of records by sampling with replacement from said correspondence table, to generate a plurality of approximate expressions representing a relation between the input variables and the output variables by carrying out, a plurality of times, a processing to calculate the approximate expression from the read records, and storing data of said plurality of approximate expressions into a storage device, and to calculate, for each of said plurality of approximate expressions, which are stored in said storage device, a feasible region for at least one of the predetermined input variables and the predetermined output variables, and to store data of said feasible region into a feasible region storage device; and
an output unit to generate display data to display the superimposed feasible regions for said plurality of approximate expressions, which are stored in said feasible region storage device, and to output said display data to an output device.

6. A computer algebra apparatus, comprising:
a memory configured to store a plurality of first sets of predetermined input variable values;
a processor configured to execute a procedure, the procedure comprising;
obtaining, for each of first sets stored in the memory, a second set of predetermined output variable values from a model to be investigated, and to store the predetermined output variable values obtained for a certain second set into a correspondence table in association with the predetermined input variable values for a certain first set corresponding to the certain second set;
reading out a predetermined number of records by sampling with replacement from said correspondence table, to generate a plurality of approximate expressions representing a relation between the input variables and the output variables by carrying out, a plurality of times, a processing to calculate the approximate expression from the read records, and storing data of said plurality of approximate expressions into a storage device, and to calculate, for each of said plurality of approximate expressions, which are stored in said storage device, a feasible region for at least one of the predetermined input variables and the predetermined output variables, and to store data of said feasible region into a feasible region storage device; and
generating display data to display the superimposed feasible regions for said plurality of approximate expressions, which are stored in said feasible region storage device, and to output said display data to an output device.

7. A computer algebra method, comprising:
obtaining, for each of first sets stored in an input variable value storage device storing a plurality of first sets of predetermined input variable values, a second set of predetermined output variable values from a model to be investigated, and storing the predetermined output variable values obtained for a certain second set into a correspondence table in association with the predetermined input variable values for a certain first set corresponding to the certain second set;
reading out a predetermined number of records by sampling with replacement from said correspondence table, generating a plurality of approximate expressions representing a relation between the input variables and the output variables by carrying out, a plurality of times, a processing to calculate the approximate expression from the read records, and storing data of said plurality of approximate expressions into a storage device;
calculating, for each of said plurality of approximate expressions, which are stored in said storage device, a feasible region for at least one of the predetermined input variables and the predetermined output variables, and storing data of said feasible region into a feasible region storage device; and
generating display data to display the superimposed feasible regions for said plurality of approximate expressions, which are stored in said feasible region storage device, and outputting said display data to an output device.
